(19) United States
(12) Patent Application Publication
(10) Pub. No.: US 2012/0209976 A1
(43) Pub. Date: Aug. 16, 2012

(54) REMOTE MANAGEMENT AND CONTROL USING COMMON INTERNET PROTOCOLS

(76) Inventor: PHILIP A. MCQUADE, Annapolis, MD (US)

(21) Appl. No.: 13/372,263

(22) Filed: Feb. 13, 2012

Related U.S. Application Data
(60) Provisional application No. 61/463,286, filed on Feb. 15, 2011.

(51) Int. Cl. G06F 15/173

(52) U.S. Cl. 709/223

(57) ABSTRACT

A network management system and methods for remote or local management of computer networking devices. The network management system comprises at least one networking device associated with a LAN; a controller that utilizes application layer protocols to code data and encapsulate the data into at least one transport layer protocol that uses lower layer protocols to effect data transfer; and of a client. The client periodically contacts and interfaces with the controller by utilizing application layer protocols to code data and encapsulate the data into at least one transport layer protocol that uses lower layer protocols to effect data transfer, and communicates with the networking device to mediate data in the computer network.

### RELATED APPLICATIONS

This application claims priority to U.S. provisional application No. 61/463,286, filed on Feb. 15, 2011, which is hereby incorporated by reference in its entirety.

### FIELD

The present disclosure relates to methods, systems, and products used in computer networks, specifically to the remote or local control of computer networking devices.

### BACKGROUND

Computer networking devices are units that mediate data in a computer network. Common networking devices include for example, access points, switches, and routers. Importantly, increasing and already extensive use of computers has created a demand for larger networks. For example, the inconvenience of having to connect devices to a physical wired infrastructure in order to communicate with a data network has resulted in the extensive deployment of access points that provide wireless connectivity to a network (known as “wireless access points”). Such devices create a wireless zone in which other devices with compatible wireless communication characteristics can obtain access to a network. The use of smart phones, tablet notebooks, e-readers and other handheld devices that have compatible wireless communication characteristics is also expanding rapidly; these devices can also use wireless access points to obtain access to a network. As a result, many places, such as e.g., hotels or convention centers, try to deploy many wireless access points to accommodate the needs of their customers.

Wireless access points may also be incorporated into a router or some other device that provides routing functionality. These devices may be referred to as “wireless routers,” and connect directly to a network, such as a third party Internet Service Provider (“ISP”). Wireless routers may also incorporate a variety of additional functions such as a DHCP server and a DNS server. Other features wireless routers may provide include additional network management controls, such as e.g., the option of modifying various parameters to determine the appropriate amount of access for its user devices.

One wireless router or access point may not establish a sufficient wireless zone for user devices to connect to. In other words, multiple routers or access points may need to be deployed in order to create a larger wireless zone. Typically, multiple wireless routers are not used for this situation. Instead, multiple wireless access points are deployed. These wireless access points are typically connected by dedicated wiring or secondary wireless connections or through one or more intermediate devices such as network switches and other transport mechanisms, to a router that may be connected to the public Internet. Sometimes a controller is installed in the same local area network (“LAN”) to manage and control the interaction of the wireless access points, user devices connected through the wireless access points, and routers.

Such advancements, however, have corresponding challenges. For example, large networks are difficult to install and maintain. Several techniques have been proposed or implemented to address this problem. Currently, it is possible to manage a network of routers, access points, and other similar devices (collectively referred to herein as “networking devices”) with a controller located within the same LAN. One particular challenge is that network management from a controller located outside the same LAN has mostly only been possible where the networking devices are associated with (1) a routable IP address, or (2) an equivalent port-mapped access through a routable IP address. As a result, the installation and maintenance of a large network is still time consuming, expensive, and requires specialized knowledge.

### SUMMARY

As described more fully below, the embodiments of the present disclosure relate to a network management system and apparatus for remote or local management of computer networking devices.

To this end, a disclosed network management system, comprises at least one networking device associated with a LAN, said at least one networking device being one of an access point, router or network switch; a controller that utilizes application layer protocols to code data and encapsulate the data into at least one transport layer protocol that uses lower layer protocols to effect data transfer; and a client, wherein the client periodically contacts and interfaces with the controller utilizing application layer protocols to code data and encapsulate the data into at least one transport layer protocol that uses lower layer protocols to effect data transfer, and communicates with the networking device to mediate data in a computer network.

In some embodiments, the controller instructs the client to effect restrictions on user devices that connect to the networking device. The system may also have the restrictions comprise at least one of: restricting user devices from communicating with other user devices within the LAN, restricting user devices to only access a set of pre-specified locations, restrictions on bandwidth that may be used, duration of access to the network, maximum aggregate throughput, or maximum instantaneous throughput rate, and restrictions on time of access to specific windows. The system may also have the controller instruct the client to effect verification requirements on user devices that connect to the networking device. The system may have the verification requirements comprise at least one of: successful completion of an authentication process of a login credential, a verification of hardware address, agreement to terms and conditions, the maintenance of a list of user devices which are authorized at the time of the request, to access the network, and self-registration, voucher/coupon submittal or payment. The system may also have the controller and client located on different LANs or WANs. The system may also have the client and the controller incorporated into one device. The system may also have the application layer protocols as HTTP, SMTP, and FTP. The system may also have the client integrated into a networking device. The system may also have the controller manage a plurality of networking devices on a plurality of LANs.

In another embodiment, a disclosed controller method of managing a computer network, comprises storing commands for mediating data in the computer network on a non-transient computer storage medium; receiving periodic network communications from a client in the form of application layer protocols that codes data and encapsulates the data into at least one transport layer protocol that uses lower layer protocols to effect data transfer; and sending the commands to the client by application layer protocols that codes data and encapsulates the data into at least one transport layer protocol that uses lower layer protocols to effect data transfer.

In some embodiments, the commands instruct the client to effect restrictions on user devices that connect to a networking device. The method may also have the commands instruct the client to effect verification requirements on user devices that connect to a networking device. The method may also have the application layer protocols as HTTP, SMTP, and FTP. The method may also have the controller process and client located on different LANs.

In yet another embodiment, a disclosed client method for managing a network, comprises storing commands for mediating data in the computer network on a non-transient computer storage medium; sending periodic network communications to a controller in the form of application layer protocols that codes data and encapsulates the data into at least one transport layer protocol that uses lower layer protocols to effect data transfer; receiving the commands from a controller by application layer protocols that codes data and encapsulates the data into at least one transport layer protocol that uses lower layer protocols to effect data transfer; sending the commands to a networking device to effect the commands for mediating data in a computer network; and receiving communications from the networking device.

In some embodiments, the commands instruct the client to effect restrictions on user devices that connect to the networking device. The method may also have the commands instruct the client to effect verification requirements on user devices that connect to a networking device. The method may also have the application layer protocols as HTTP, SMTP, and FTP. The method may also have the controller and the client process located on different LANs.

These, as well as other components, steps, features, objects, benefits, and advantages will now become clear from a review of the following detailed description of illustrative embodiments, the accompanying drawings and the claims. It is to be expressly understood, however, that the drawings are for the purpose of illustration only and are not intended as a definition of the limits of the claimed embodiments.

### BRIEF DESCRIPTION OF THE DRAWINGS

The drawings disclose illustrative embodiments. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it is intended to refer to the same or like components or steps.

FIG. 1 is a diagram illustrating one embodiment of a system according to aspects of the present disclosure.

FIGS. 2A to 2E illustrate various configurations of the client, access point, and router illustrated in FIG. 1.

FIG. 3 illustrates the functioning of a controller in greater detail.

FIG. 4 illustrates the functioning of a client in greater detail.

FIGS. 5A and 5B illustrate various configurations of the controller with respect to a LAN where a client is located.

FIG. 6 illustrates one possible sequence for managing a network in accordance with the disclosed principles.

FIG. 7 illustrates a table that might be maintained at the client.

FIG. 8 illustrates a table that might be maintained at the server.

### DETAILED DESCRIPTION OF ILLUSTRATIVE EMBODIMENTS

Illustrative embodiments are now discussed. Other embodiments may be used in addition or instead. Details that may be apparent or unnecessary may be omitted to save space or for a more effective presentation. Conversely, some embodiments may be practiced without all of the details that are disclosed.

Networking technologies are generally described with respect to two network models. The prescriptive model is the Open Systems Interconnection (“OSI”) model. There are seven layers to this OSI model: (1) physical layer, (2) data link layer, (3) network layer, (4) transport layer, (5) session layer, (6) presentation layer, and (7) application layer. The descriptive model is the Transmission Control Protocol/Internet Protocol (“TCP/IP”). This model may be described in four layers: (1) link layer, (2) interne layer, (3) transport layer, and (4) application layer. Since both models describe network technologies, there are well-known equivalents between the two. For example, TCP/IP layer 4 is known as the application layer and it is generally equivalent to OSI layer 7, which is also known as an application layer. Such application layer protocols, by way of example but without limitation, are Hypertext Transmission Protocol (HTTP), Simple Mail Transfer Protocol (SMTP), and File Transfer Protocol (FTP). While the present disclosure is not limited to any particular network model, the examples used herein generally refer to the TCP/IP model unless otherwise specified.

Generally, the management of routers, access points, and other similar devices (collectively referred to as “networking devices”) required the controller to be located within the same LAN. As used herein, when two devices are described as “local” to one another, they are both located within the same LAN, and when two devices are described as “remote” or “remotely-located” the devices are not located within the same LAN. For avoidance of ambiguity, the term LAN as used in this application is used in the conventionally understood sense: it is equivalent to the broadcast domain of the underlying Ethernet protocol, or a broadcast domain's equivalent in other, non-Ethernet topologies. In other words, the boundaries of the LAN are at the routers, and therefore any Internet traffic that passes through a router is crossing the boundaries of the LAN in which it originated. Additionally, a wide area network (“WAN”) is a computer network that connects LANs together.

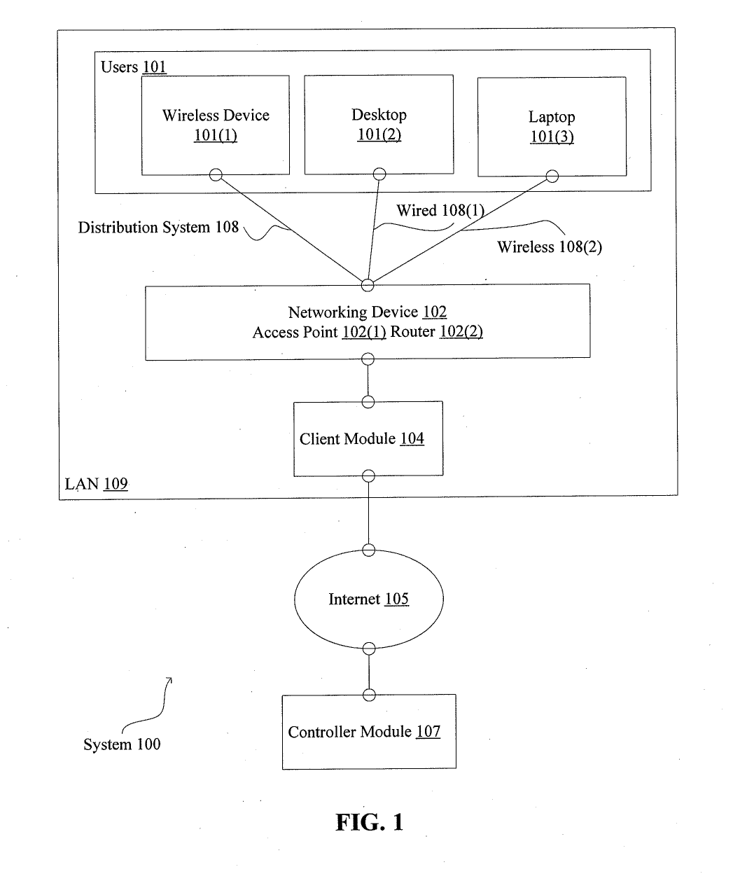

FIG. 1 is a diagram illustrating one embodiment of a system 100 according to aspects of the present disclosure. The system 100 includes user devices 101, at least one networking device 102, client 104 and a controller 107 connected over a LAN 109 to the Internet 105. FIG. 1 shows an example, not by way of limitation, of user devices 101 such as wireless devices 101(1), desktop computers 101(2), and laptops 101(3). User devices 101 communicate with the networking devices 102 using various distribution systems 108 such as e.g., a direct connection through a physical line 108(1) or a wireless connection 108(2). User devices 101 communicate to outside networks, such as the Internet 105, by connecting to a networking device 102. The client 104 manages a network by providing instructions to the networking devices 102. The client 104 communicates to the controller 107 by utilizing an application layer protocol to deliver a signal through the Internet 105. The controller 107 may in turn respond by sending a signal back to the client 104 with a set of rules for the client 104 to apply to the networking devices 102. This will enable those wishing to install networking devices 102 to fully control and manage, and to the extent desired restrict, access to the LAN 109 and the Internet 105 using a controller 107 located anywhere in the world. The client and the controller may be implemented as a computer method, a computing system or as an article of manufacture such as a computer program product. The computer program product may be computer storage medium readable by a computer system and encoding a computer program of instructions for executing a computer method.

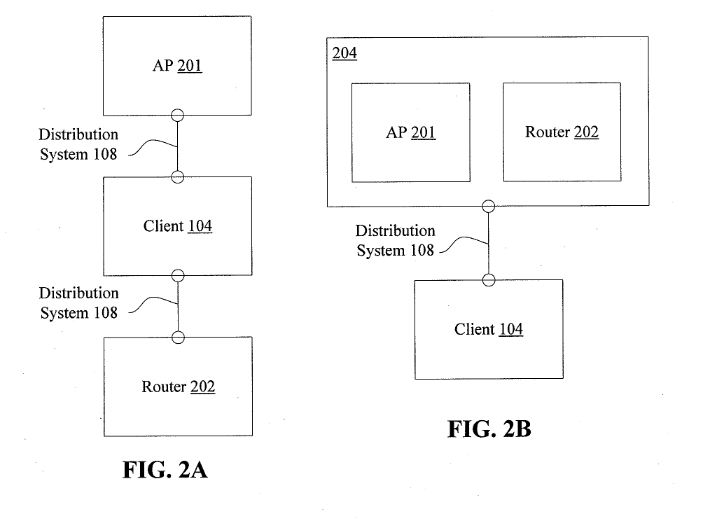

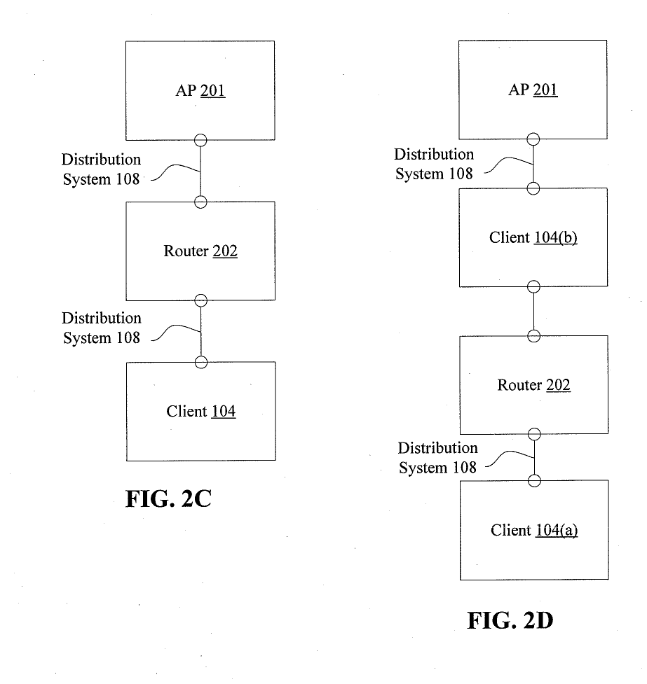

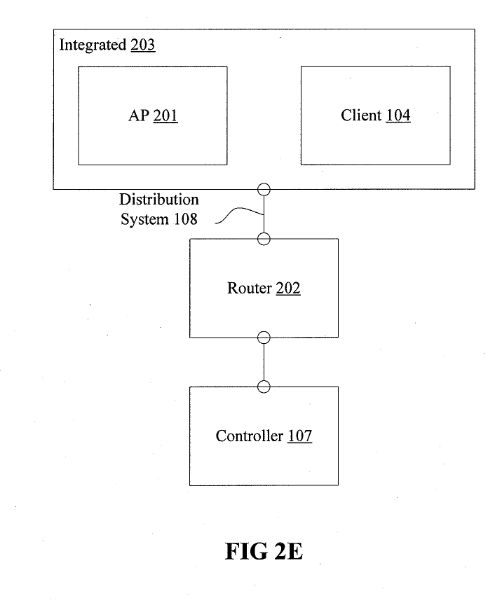

FIG. 2A illustrates one example configuration of the client 104 and two networking devices shown as an access point (“AP”) 201 and a router 202. In this configuration, the access point 201 interfaces with the client 104 before interfacing with the router 202.

FIG. 2B illustrates another example configuration where the client 104 interfaces with an access point 201 integrated 204 with the router 202.

FIG. 2C illustrates another example configuration where the client 104 interfaces with the 202 and the router 202 then connects to the access point 201 by use of a distribution system 108.

FIG. 2D illustrates an example configuration having multiple clients 104(a), 104(b). In the illustrated embodiment, the router 202 and an access point 201 have their own respective client 104(a), 104(b). This would allow for more granular management of the network.

FIG. 2E illustrates one configuration where the AP 201 and the client 104 are integrated 203 into the same device. For example, the client 104 may be implemented as a computer method on a non-transient computer storage medium that is incorporated into the AP 201. The client method comprises storing commands for mediating data in a computer network, sending periodic network communications to a controller, receiving commands from a controller 107, sending the commands to the AP 201, and receiving communications from the AP 201.

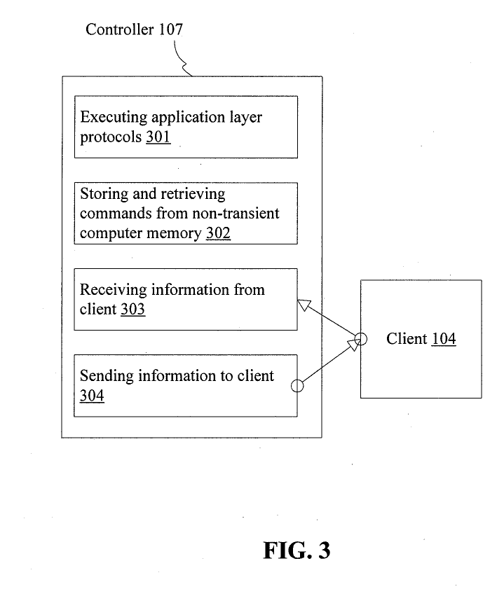

FIG. 3 illustrates the functioning of the controller 107 in greater detail. The controller 107 includes a processor and a memory used for implementing the illustrated functions. The memory can be any type of memory suitable for a computer application including, but not limited to, non-transient computer readable memory such as NVRAM. As shown in FIG. 3, the controller's 107 example functions comprise executing application layer protocols (with the processor) 301, receiving periodic signals from the client 303, sending instructions to the client 304, and storing and retrieving commands from non-transient computer memory 302. The sending information to (304) and receiving (303) information utilize an application layer protocol. The controller 107 may be a device located outside the LAN, regardless of whether the networking devices are associated with a routable address, or with an equivalent port-mapped access through a routable IP address.

The combination of receiving periodic signals from the client 303, and the use of a standard application protocol, allows the signals from the client 104 to successfully traverse firewalls, NAT and PNAT gateways and proxy servers with minimal interference, maximizing the reliability and consistency of the communication between the client 104 and controller 107. The availability of a scheduled and reliable inbound stream of polls from the client 104 allows the controller 107 to manage the client 104 as effectively as if it were locally connected.

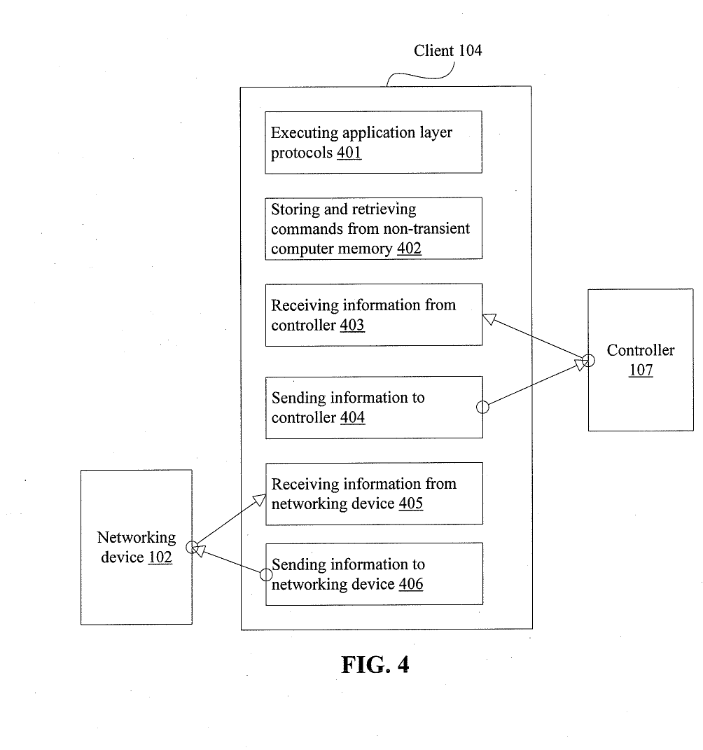

FIG. 4 illustrates the functioning of the client 104 in greater detail. The client 104 includes a processor and a memory used for implementing the illustrated functions. The memory can be any type of memory suitable for a computer application including, but not limited to, non-transient computer readable memory such as NVRAM. As shown in FIG. 4, example client 104 functions include executing application layer protocols 401, storing and retrieving commands from non-transient computer memory 402, sending a signal or information to the controller 404, receiving information from the controller 403, receiving information from a networking device 405, and sending information to a networking device 406. The functions of sending information to (404) and receiving information from (403) the controller 107 utilize an application layer protocol. The functions of sending information to (406) and receiving information from (405) the networking device 102 utilize either a transport layer or internet layer protocol. The client may be arranged in various configurations with respect to the networking devices, as illustrated in FIGS. 2A to 2D.

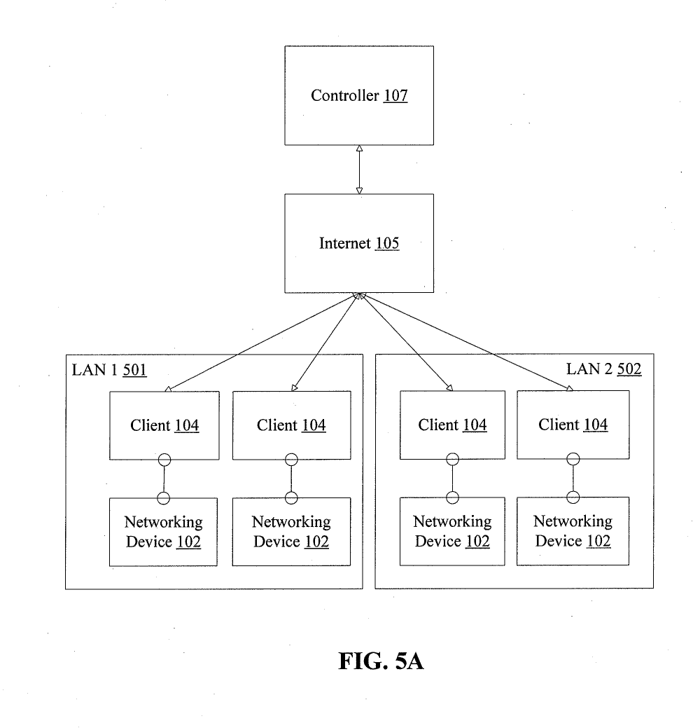

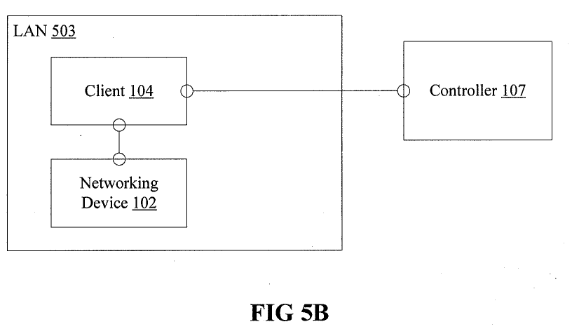

FIG. 5A is another embodiment that further illustrates the flexibility of the principles disclosed herein. As shown in FIG. 5A, a single controller 107 may manage the networking devices 102 of two separate LANs 501, 502. Although only two LANs 501, 502 are illustrated, it should be appreciated that a single controller may manage more than two separate LANs.

FIG. 5B illustrates that the flexibility of the disclosure may be implemented when the client 104 is on the same LAN 503 as the controller 107.

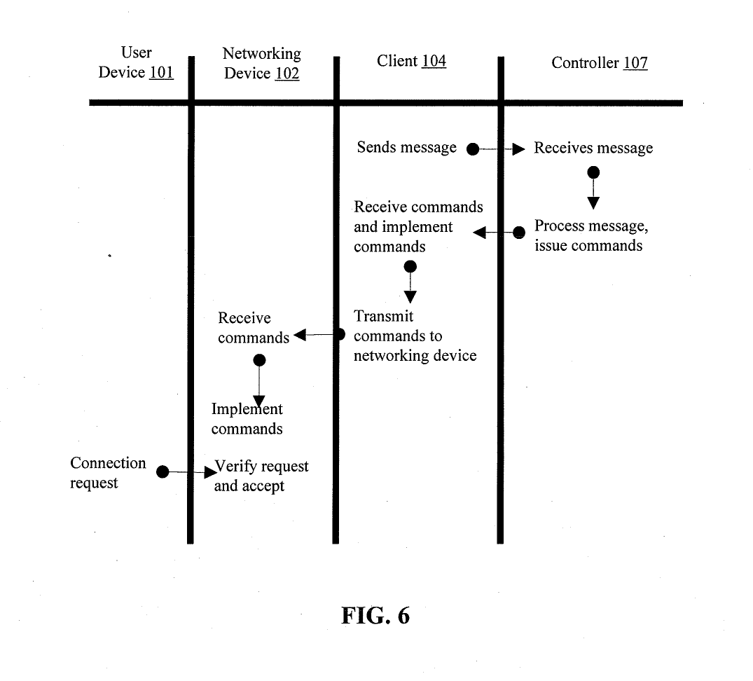

FIG. 6 illustrates one possible sequence for managing a network in accordance with the principles disclosed herein. In the typical sequence, the client 104 sends to the controller 107 a message packaged in an application layer protocol. The controller 107 receives the message, processes the message, and then packages its commands into an application layer protocol. Various commands may comprise of many various parameters, such as e.g., managing the internal workings of the networking devices 102, implementing user device verification procedures, or implementing user device restrictions. The command is sent to the client 104 where the command is processed before transmitting it to a networking device 102, which implements the command(s). The implementation of these commands may require a user device 101 to satisfy any requirements, such as e.g., providing self-registration, voucher/coupon submittal or payment, before connecting to the networking device 102.

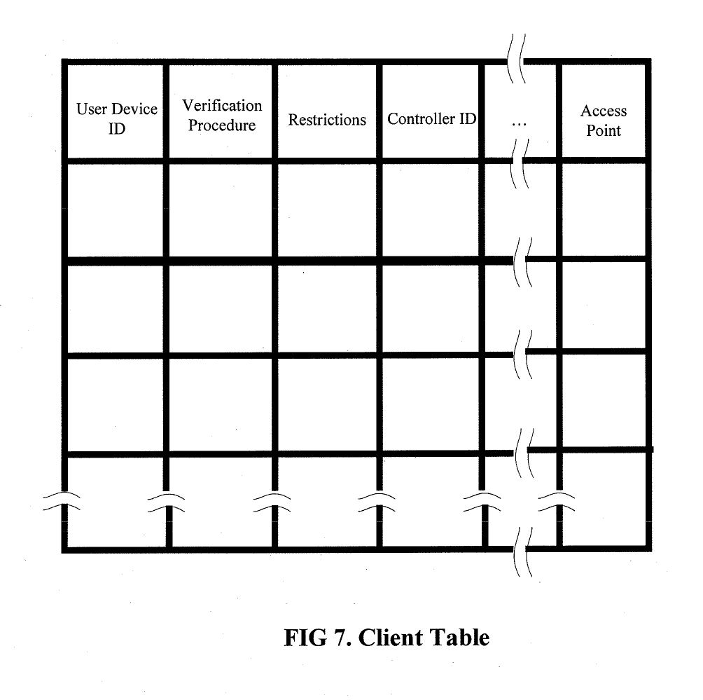

FIG. 7 illustrates a table that might be maintained at the client 104. There are several uses for the table entries, such as implementing verification procedures and various restrictions for user devices. The table may list and correlate a user device ID, verification procedure, restrictions, controller ID, router ID, access point or other networking devices as desired.

One feature may be to implement various verification procedures for user devices so that whenever a user device requests access through the networking device, the networking device may prohibit access for the user device until certain requirements are fulfilled. These requirements may be the (1) successful completion of an authentication process of a login credential. (2) a verification of hardware address, (3) agreement to terms and conditions, (4) the maintenance of a list of user devices which are authorized at the time of the request, to access the network or (5) until the device provides sufficient input, such as self-registration, voucher/coupon submittal or payment.

Another feature may be to implement various restrictions for user devices. Specifically, whenever a device requests authorization to connect to the network through a networking device, the networking device may restrict the user device's access to the network. These various restrictions may be that (1) user devices may be restricted from communicating with other user devices within the LAN, (2) user devices are restricted to only access to a set of pre-specified locations, known as a walled garden, (3) restrictions on bandwidth that may be used, (4) duration of access to the network, (5) maximum aggregate throughput, or maximum instantaneous throughput rate, or (6) restrictions on time of access to specific windows (e.g., 9 am-10 pm).

Yet another feature is the combination of verification and restriction procedures. For example, any number of lists may be maintained which will authorize level of access, or deny access to devices requesting connection to the network through the networking devices.

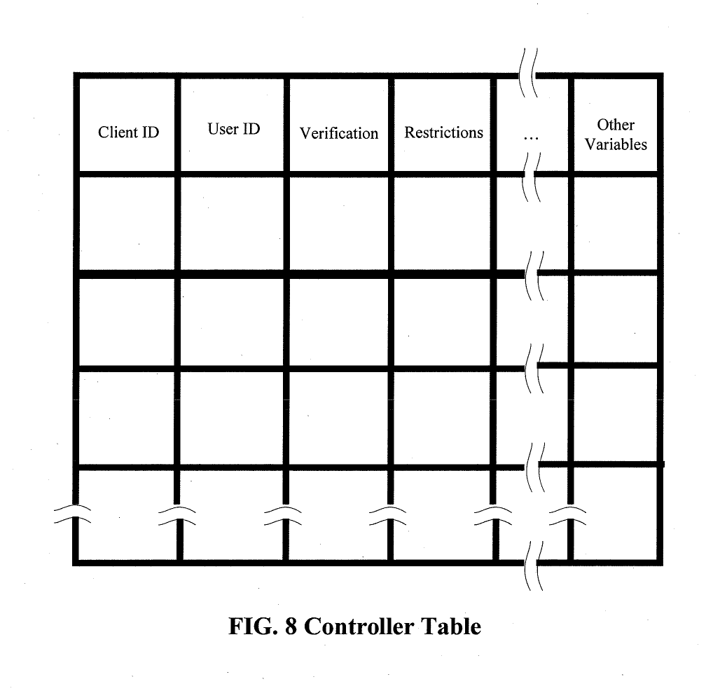

FIG. 8 illustrates a table that might be maintained at the controller. There are several uses for the table entries, which correspond with the verification and restriction procedures effected through the client. The table may list and correlate a client ID, user device ID, verification procedure, and restrictions.

One feature may be to implement various verification procedures for user devices so that whenever a user device requests access through the networking device, the networking device may prohibit access for the user device until certain requirements are fulfilled. These requirements may be the (1) successful completion of an authentication process of a login credential. (2) a verification of hardware address, (3) agreement to terms and conditions, (4) the maintenance of a list of user devices which are authorized at the time of the request, to access the network or (5) until the user device provides sufficient input, such as self-registration, voucher/coupon submittal or payment.

Another feature may be to implement various restrictions for user devices. Specifically, whenever a device requests authorization to connect to the network through a networking device, the networking device may restrict the user device's access to the network. These various restrictions may be that (1) user devices may be restricted from communicating with other user devices within the LAN, (2) user devices are restricted to only access to a set of pre-specified locations, known as a walled garden, (3) restrictions on bandwidth that may be used, (4) duration of access to the network, (5) maximum aggregate throughput, or maximum instantaneous throughput rate, or (6) restrictions on time of access to specific windows (e.g., 9 am-10 pm).

Yet another feature is the combination of verification and restriction procedures. For example, any number of lists may be maintained which will authorize level of access, or deny access to devices requesting connection to the network through the networking devices.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

What is claimed is:

1. A network management system, comprising:
at least one networking device associated with a LAN, said at least one networking device being one of an access point, router or network switch;
a controller that utilizes application layer protocols to code data and encapsulate the data into at least one transport layer protocol that uses lower layer protocols to effect data transfer; and
a client, wherein the client periodically contacts and interfaces with the controller utilizing application layer protocols to code data and encapsulate the data into at least one transport layer protocol that uses lower layer protocols to effect data transfer, and communicates with the networking device to mediate data in a computer network.

2. The system of claim 1, wherein the controller instructs the client to effect restrictions on user devices that connect to the networking device.

3. The system of claim 2, wherein the restrictions comprise at least one of:
restricting user devices from communicating with other user devices within the LAN,
restricting user devices to only access a set of pre-specified locations,
restrictions on bandwidth that may be used,
duration of access to the network,
maximum aggregate throughput, or maximum instantaneous throughput rate, and
restrictions on time of access to specific windows.

4. The system of claim 1, wherein the controller instructs the client to effect verification requirements on user devices that connects to the networking device.

5. The system of claim 4, wherein the verification requirements comprise at least one of:
successful completion of an authentication process of a login credential,
a verification of hardware address,
agreement to terms and conditions,
the maintenance of a list of user devices which are authorized at the time of the request, to access the network, and
self-registration, voucher/coupon submittal or payment.

6. The system of claim 1, wherein the controller and client are located on different LANs or WANs.

7. The system of claim 1, wherein the client and the controller are incorporated into one device.

8. The system of claim 1, wherein the application layer protocols are HTTP, SMTP, and FTP.

9. The system of claim 1, wherein the client may be integrated into a networking device.

10. The system of claim 1, wherein the controller manages a plurality of networking devices on a plurality of LANs.

11. A controller method of managing a computer network, said method comprising:
storing commands for mediating data in the computer network on a non-transient computer storage medium;
receiving periodic network communications from a client in the form of application layer protocols that codes data and encapsulates the data into at least one transport layer protocol that uses lower layer protocols to effect data transfer; and
sending the commands to the client by application layer protocols that codes data and encapsulates the data into at least one transport layer protocol that uses lower layer protocols to effect data transfer.

12. The method of claim 11, wherein the commands instruct the client to effect restrictions on user devices that connect to a networking device.

13. The method of claim 11, wherein the commands instruct the client to effect verification requirements on user devices that connect to a networking device.

14. The method of claim 11, wherein the application layer protocols are HTTP, SMTP, and FTP.

15. The method of claim 11, wherein the controller process and client are located on different LANs.

16. A client method for managing a network, comprising:
storing commands for mediating data in the computer network on a non-transient computer storage medium;
sending periodic network communications to a controller in the form of application layer protocols that codes data and encapsulates the data into at least one transport layer protocol that uses lower layer protocols to effect data transfer;
receiving the commands from a controller by application layer protocols that codes data and encapsulates the data into at least one transport layer protocol that uses lower layer protocols to effect data transfer;
sending the commands to a networking device to effect the commands for mediating data in a computer network; and
receiving communications from the networking device.

17. The method of claim 16, wherein the commands instructs the client to effect restrictions on user devices that connect to the networking device.

18. The method of claim 16, wherein the commands instructs the client to effect verification requirements on user devices that connect to a networking device.

19. The method of claim 16, wherein the application layer protocols are HTTP, SMTP, and FTP.

20. The method of claim 16, wherein the controller and the client process are located on different LANs.
